(19) United States
(12) Patent Application Publication
(10) Pub. No.: US 2013/0112041 A1
(43) Pub. Date: May 9, 2013

(54) HYBRID ROTOR-CLUTCH SYSTEM

(71) Applicants: Goro Tamai, West Bloomfield, MI (US); Scott A. Miller, Northville, MI (US); Travis J. Miller, Romulus, MI (US); David E. Klingston, Shelby Township, MI (US)

(72) Inventors: Goro Tamai, West Bloomfield, MI (US); Scott A. Miller, Northville, MI (US); Travis J. Miller, Romulus, MI (US); David E. Klingston, Shelby Township, MI (US)

(21) Appl. No.: 13/662,932

(22) Filed: Oct. 29, 2012

Related U.S. Application Data
(60) Provisional application No. 61/556,402, filed on Nov. 7, 2011.

(51) Int. Cl. F16D 21/04

(52) U.S. Cl. 74/665 F; 192/48.1

(57) ABSTRACT

A hybrid dual clutch transmission having a hybrid rotor-clutch system. The hybrid rotor-clutch system includes an engine disconnect clutch that selectively couples an engine to the rotor of an electric motor within the hybrid dual clutch transmission. A first clutch disk selectively couples a first input shaft of the hybrid dual clutch transmission to a first surface of the web of the rotor and a second clutch disk selectively couples a second input shaft of the hybrid dual clutch transmission to a second surface of the web of the rotor.

### CROSS REFERENCE TO RELATED APPLICATION

This application claims the benefit of U.S. Provisional Ser. No. 61/556,402, filed Nov. 7, 2011.

### FIELD

The present disclosure relates to a hybrid dual clutch transmission and, more particularly, to a hybrid dual clutch transmission in which the rotor of an electric motor serves as a mating surface for an engine disconnect clutch and the two clutches of the dual clutch transmission.

### BACKGROUND

Dual clutch transmissions are low-loss, efficient transmissions that are desirable for use with an electric motor in hybrid vehicle applications. However, the design of dual clutch transmissions makes creating a compact transmission incorporating an electric motor difficult. Current hybrid dual clutch transmissions typically provide for the attachment of an electric motor to only one of a first countershaft carrying a first plurality of gears or a second countershaft carrying a second plurality of gears. Thus, when the electric motor is attached to the first countershaft carrying the first plurality of gears, the electric motor cannot power the second plurality of gears carried by the second countershaft. Likewise, when the electric motor is attached to the second countershaft carrying the second plurality of gears, the electric motor cannot power the first plurality of gears carried by the first countershaft. The addition of clutches to couple the electric motor to both the first and second countershafts, and thus the first and second plurality of gears, typically increases the size of the hybrid dual clutch transmission. This makes placement of the hybrid dual clutch transmission in a vehicle difficult, particularly for a front-wheel drive vehicle in which the engine is transversely mounted. Therefore, it is recognized that improvement is needed in the art.

### SUMMARY

In one form, the present disclosure provides a hybrid dual clutch transmission including a disconnect clutch assembly, an electric motor having an electric motor rotor, a first clutch assembly, and a second clutch assembly. The disconnect clutch assembly is selectively coupled to the rotor, the first clutch assembly selectively couples the rotor to a first plurality of gears, and the second clutch assembly selectively couples the rotor to a second plurality of gears.

In another form, the present disclosure provides a transmission including a disconnect clutch assembly. The disconnect clutch assembly includes a flywheel and a disconnect clutch disk. The transmission also includes an electric motor having an electric motor rotor with an electric motor rotor web, a first clutch assembly having a first clutch disk, a second clutch assembly having a second clutch disk, a first input shaft coupled to the first clutch disk, and a second input shaft coupled to the second clutch disk. The disconnect clutch disk selectively couples the flywheel to a first surface of the rotor, the first clutch disk selectively couples a first surface of the rotor web to the first input shaft, and the second clutch disk selectively couples a second surface of the rotor web to the second input shaft.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a stick drawing of a hybrid dual clutch transmission having a hybrid rotor-clutch system according to an embodiment disclosed herein;

FIG. 2 is a cutaway drawing of the hybrid dual clutch transmission having the hybrid rotor-clutch system of FIG. 1; and

FIG. 3 is a cutaway drawing of a hybrid dual clutch transmission having a hybrid rotor-clutch system according to another embodiment disclosed herein.

### DETAILED DESCRIPTION

To optimize the performance of the hybrid dual clutch transmission for operations such as regenerative breaking, the electric motor should be capable of being continuously connected to the transmission output, such as the ring gear. Thus, it is desirable that the electric motor be capable of being independently coupled to the first countershaft carrying the first plurality of gears and the second countershaft carrying the second plurality of gears so that the electric motor is always capable of being coupled through the engaged gear to the transmission output shaft. It is also desirable that the electric motor be capable of being disconnected from the engine to permit propulsion of the vehicle exclusively under efficient electric power.

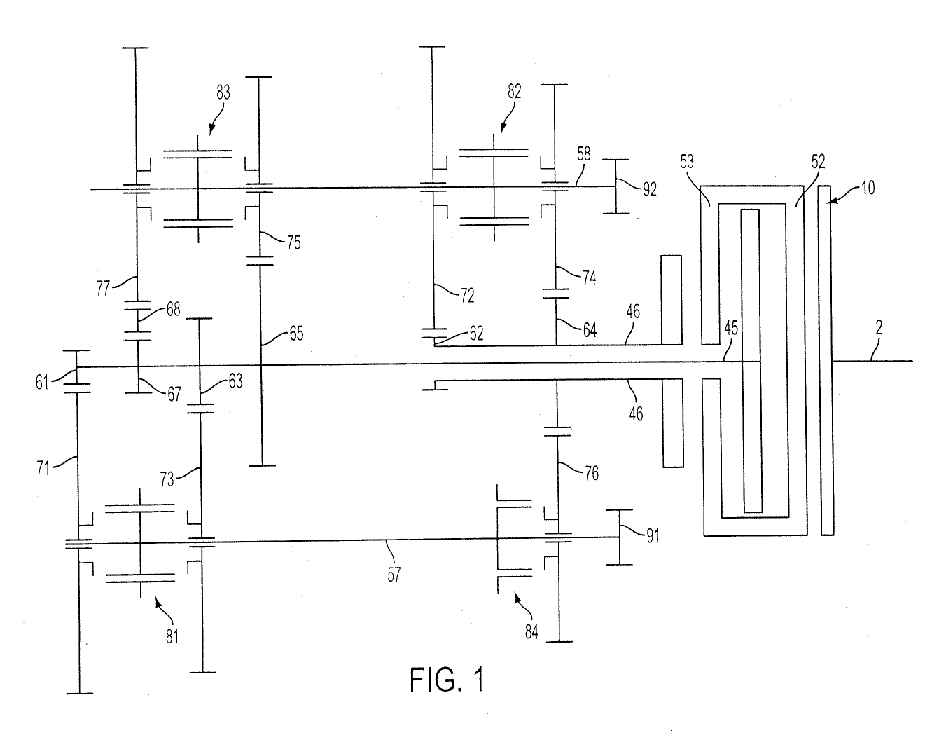

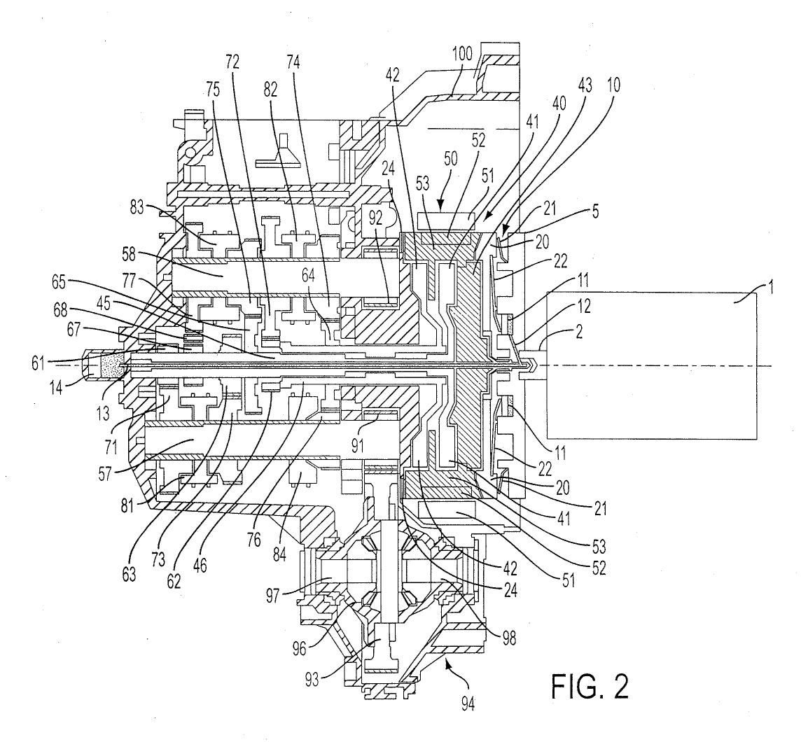

FIG. 1 illustrates a stick drawing of a hybrid dual clutch transmission having a hybrid rotor-clutch system. The hybrid dual clutch transmission includes a crankshaft hub 2 coupled to a disconnect clutch assembly 10. The disconnect clutch assembly 10 selectively couples the crankshaft hub 2 to an electric motor rotor 52. The rotor 52 is coupled to an electric motor rotor web 53 of an electric motor 50 (FIG. 2) within the hybrid dual clutch transmission. An electric motor stator 51 (FIG. 2) of the electric motor 50 is attached to a transmission housing 100 (FIG. 2). The rotor web 53 may be selectively coupled to a first clutch disk 41 (FIG. 2) or a second clutch disk 42 (FIG. 2). The first clutch disk 41 is coupled to a first input shaft 45 and the second clutch disk 42 is coupled to a second input shaft 46 that is concentric with and surrounds at least a portion of the first input shaft 45.

The first input shaft 45 includes a plurality of fixedly attached gears 61, 63, 65, 67, including a first driver gear 61, a third driver gear 63, a fifth driver gear 65, and a reverse driver gear 67. A plurality of gears 62, 64 are fixedly attached to the second input shaft 46. The gears 62, 64 fixedly attached to the second input shaft 46 include a second driver gear 62 and a fourth/sixth driver gear 64.

The hybrid dual clutch transmission also includes a first countershaft 57 and a second countershaft 58, each disposed about a different axis from each other, the first input shaft 45 and the second input shaft 46. The first countershaft 57 includes a plurality of rotatably attached gears 71, 73, 76 and at least one fixedly attached gear 91. The rotatably attached gears include a first driven gear 71, a third driven gear 73, and a sixth driven gear 76. The rotatably attached gears 71, 73, 76 are capable of rotating independently of the first countershaft 57. A first final drive pinion 91 is fixedly attached to the first countershaft 57 and rotates with the same angular velocity as the first countershaft 57. The second countershaft 58 includes a plurality of rotatably attached gears 72, 74, 75, 77 and at least one fixedly attached gear 92. The rotatably attached gears include a second driven gear 72, a fourth driven gear 74, a fifth driven gear 75, and a reverse driven gear 77. The rotatably attached gears 72, 74, 75, 77 are capable of rotating independently of the second countershaft 58. A second final drive pinion 92 is fixedly attached to the second countershaft 58 and rotates with the same angular velocity as the second countershaft 58.

Respective gears on the first input shaft 45, second input shaft 46, first countershaft 57, and second countershaft 58 are continuously meshed with one another. In particular, the first driven gear 71 is continuously meshed with the first driver gear 61, the second driven gear 72 is continuously meshed with the second driver gear 62, the third driven gear 73 is continuously meshed with the third driver gear 63, and the fifth driven gear 75 is continuously meshed with the fifth driver gear 65. In addition, one of the driver gears 64 is meshed with more than one driven gear 74, 76. In particular, the fourth/sixth driver gear 64 is continuously meshed with both the fourth driven gear 74 and the sixth driven gear 76. The reverse driven gear 77 is not meshed with any gears on the first input shaft 45 or second input shaft 46. Rather, the reverse driven gear 77 is continuously meshed with a reverse idler gear 68. The reverse idler gear 68 is continuously meshed with the reverse driver gear 67.

The first countershaft 57 and second countershaft 58 further include four synchronizer mechanisms (e.g., dog clutches) 81, 82, 83, 84 to selectively key a rotatably mounted gear 71, 72, 73, 74, 75, 76, 77 to its respective first countershaft 57 or second countershaft 58. A first/third gear dog clutch 81 is attached to the first countershaft 57 between the first driven gear 71 and the third driven gear 73. The first/third gear dog clutch 81 may be moved axially along the first countershaft 57 in the direction of the first driven gear 71 or moved axially along the first countershaft 57 in the opposite direction towards the third driven gear 73. A sixth gear dog clutch 84 is also attached to the first countershaft 57 along side the sixth driven gear 76. The sixth gear dog clutch 84 may be moved axially along the first countershaft 57 in the direction of the sixth driven gear 76. A second/fourth gear dog clutch 82 is attached to the second countershaft 58 between the second driven gear 72 and the fourth driven gear 74. The second/fourth gear dog clutch 82 may be moved axially along the second countershaft 58 in the direction of the second driven gear 72 or moved axially along the second countershaft 58 in the opposite direction towards the fourth driven gear 74. A fifth/reverse gear dog clutch 83 is also attached to the second countershaft 58 between the fifth driven gear 75 and the reverse driven gear 77. The fifth/reverse gear dog clutch 83 may be moved axially along the second countershaft 58 in the direction of the fifth driven gear 75 or moved axially along the second countershaft 58 in the opposite direction towards the reverse driven gear 77.

Each of the synchronizer mechanisms 81, 82, 83, 84 may be moved axially along its respective first countershaft 57 or second countershaft 58 to contact one of the rotatably attached gears 71, 72, 73, 74, 75, 76, 77. Contact between one of the synchronizer mechanisms 81, 82, 83, 84 and a corresponding rotatably attached gear 71, 72, 73, 74, 75, 76, 77 keys the rotatably attached gear 71, 72, 73, 74, 75, 76, 77 to its corresponding synchronizer mechanism 81, 82, 83, 84 and, accordingly, to its respective first countershaft 57 or second countershaft 58. Thus, contact between the synchronizer mechanism 81, 82, 83, 84 and its respective gear 71, 72, 73, 74, 75, 76, 77 locks the gear 71, 72, 73, 74, 75, 76, 77 to its respective countershaft 57, 58 such that the gear 71, 72, 73, 74, 75, 76, 77 rotates with the same angular velocity as its respective countershaft 57, 58.

FIG. 2 illustrates a cutaway drawing of the hybrid dual clutch transmission having the hybrid rotor-clutch system of FIG. 1. The transmission housing 100 encloses and supports the components of the hybrid dual clutch transmission. An engine 1 is non-rotatably coupled to the crankshaft hub 2. The crankshaft hub 2 is non-rotatably coupled to a flywheel 5, which is coupled to a disconnect clutch assembly 10.

The disconnect clutch assembly 10 includes a disconnect clutch slave cylinder 11 mounted on the flywheel 5. The disconnect clutch slave cylinder 11 is a hydraulic cylinder fed with hydraulic or other medium by a disconnect clutch hydraulic feed 12 mounted to or within the flywheel 5. The disconnect clutch hydraulic feed 12 is coupled to a disconnect clutch oil supply shaft 13 that runs through the centers of the first input shaft 45 and second input shaft 46 to the edge of the transmission housing 100. Thus, one end of the disconnect clutch oil supply shaft 13 is coupled to the disconnect clutch hydraulic feed 12 and, thereby, the disconnect clutch slave cylinder 11. The other end of the disconnect clutch oil supply shaft 13 is coupled to a disconnect clutch oil piston 14. The disconnect clutch oil piston 14 provides hydraulic or other type of pressure to operate the disconnect clutch slave cylinder 11.

The disconnect clutch assembly 10 further includes a disconnect clutch disk 20 non-rotatably coupled to the flywheel 5. In one embodiment, the disconnect clutch disk 20 may be rotatably coupled to the flywheel 5. Disconnect clutch apply springs 21 force the disconnect clutch disk 20 into contact with at least one surface of the rotor 52, thereby non-rotatably coupling the rotor 52, disconnect clutch disk 20 flywheel 5, and crankshaft hub 2 together. A disconnect clutch diaphragm 22 is contacted by the disconnect clutch slave cylinder 11. When hydraulic or other pressure is applied to the disconnect clutch slave cylinder 11, the disconnect slave cylinder 11 engages the disconnect clutch diaphragm 22 causing the disconnect clutch diaphragm 22 to relieve pressure between the disconnect clutch disk 20 and the rotor 52, thereby permitting the rotor 52 to rotate independently of the disconnect clutch disk 20, flywheel 5, and crankshaft hub 2. In one embodiment, the default position of the disconnect clutch assembly 10 is to non-rotatably couple the rotor 52, disconnect clutch disk 20, flywheel 5, and crankshaft hub 2 together. In one embodiment, the rotor 52 and rotor web 53 are the same. In one embodiment, the contact point between the disconnect clutch disk 20 and the rotor 52 or rotor web 53 is conical. The conical contact point provides for increased torque transfer capacity between the disconnect clutch disk 20 and the rotor 52 or rotor web 53, minimizes axial forces applied to the transmission clutch assembly 40, and allows for a reduction in the size of the transmission clutch assembly 40. In one embodiment, the contact point between the disconnect clutch disk 20 and the rotor 52 or rotor web 53 is flat.

The hybrid dual clutch transmission further includes a transmission clutch assembly 40. The transmission clutch assembly 40 includes the first clutch disk 41, second clutch disk 42 and a transmission clutch cover 43. The transmission clutch cover 43 is non-rotatably coupled to the rotor web 53 or rotor 52. The transmission clutch cover 43 may apply pressure to the first clutch disk 41 or second clutch disk 42 to non-rotatably couple the first clutch disk 41 or second clutch disk 42 to the rotor web 53. The first clutch disk 41 or second clutch disk 42 may be non-rotatably coupled to the rotor web 53 individually, at the same time, or not at all. In one embodiment, the disconnect clutch disk 20 axially contacts a first side of the rotor 52, the first clutch disk 41 axially contacts a first side the rotor web 53, and the second clutch disk 42 axially contacts a second side of the rotor web 53. Thus, the odd gears of the hybrid dual clutch transmission, first driver gear 61, third driver gear 63, fifth driver gear 65, and reverse driver gear 67, are all engaged by contact of the first clutch disk 41 with the first side the rotor web 53 and the even gears of the hybrid dual clutch transmission, second driver gear 62 and fourth/sixth driver gear 64, are all engaged by contact of the second clutch disk 42 with the second side of the rotor web 53. In one embodiment, the points at which the disconnect clutch disk 20, first clutch disk 41, and second clutch disk 42 contact the rotor 52 and rotor web 53 may be varied as desired.

In one embodiment, the rotor 52 and rotor web 53 are of sufficient mass and heat capacity so as to allow for a vehicle to be launched from a standstill using only the engine 1 without assistance from the electric motor 50. The rotor 52 and rotor web 53 may be tuned to actively reduce vibrations within the hybrid dual clutch transmission and the vehicle powertrain as a whole. In one embodiment, the mass of the rotor 52 and rotor web 53 permits a reduction in the mass of the flywheel 5. In one embodiment, the hybrid dual clutch transmission further includes a thrust bearing 24 in contact with the rotor 52 or rotor web 53. The thrust bearing 24 prevents movement of the rotor 52 and rotor web 53 away from flywheel 5.

The hybrid dual clutch transmission further includes a ring gear 93 continuously meshed with the first final drive pinion 91 and the second final drive pinion 92. A differential housing 94 is coupled to the transmission housing 100. The differential housing 94 includes a differential 96 that is coupled to the ring gear 93. The differential 96 divides the torque from the ring gear 93 amongst a first halfshaft 97 and a second halfshaft 98. The first halfshaft 97 and second halfshaft 98 are connected to respective drive wheels (not shown) of the vehicle to provide propulsive force for the vehicle.

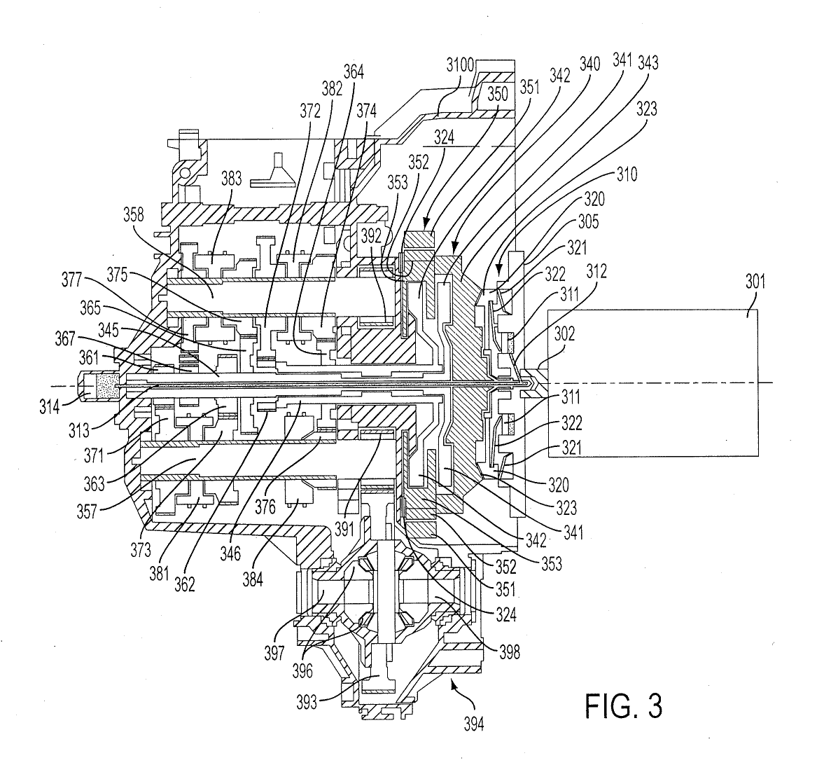

FIG. 3 is a cutaway drawing of a hybrid dual clutch transmission having a hybrid rotor-clutch system according to another embodiment. The hybrid dual clutch transmission includes an engine 301 coupled to a crankshaft hub 302. The crankshaft hub 302 is non-rotatably coupled to a flywheel 305 which is coupled to a disconnect clutch assembly 310. The disconnect clutch assembly 310 selectively couples the crankshaft hub 302 to an electric motor rotor 352 through a transmission clutch cover 343. The rotor 352 is coupled to an electric motor rotor web 353 of an electric motor 350 within the hybrid dual clutch transmission. An electric motor stator 351 of the electric motor 350 is fixedly attached to a transmission housing 3100. The transmission housing 3100 encloses and supports the components of the hybrid dual clutch transmission. The rotor web 353 may be selectively coupled to a first clutch disk 341 or a second clutch disk 342. The first clutch disk 341 is coupled to a first input shaft 345 and the second clutch disk 342 is coupled to a second input shaft 346 that is concentric with and surrounds at least a portion of the first input shaft 345.

The disconnect clutch assembly 310 includes a disconnect clutch slave cylinder 311 mounted on the flywheel 305. The disconnect clutch slave cylinder 311 is a hydraulic cylinder fed with hydraulic or other medium by a disconnect clutch hydraulic feed 312 mounted to or within the flywheel 305. The disconnect clutch hydraulic feed 312 is coupled to a disconnect clutch oil supply shaft 313 that runs through the centers of the first input shaft 345 and second input shaft 346 to the edge of the transmission housing 3100. Thus, one end of the disconnect clutch oil supply shaft 313 is coupled to the disconnect clutch hydraulic feed 312 and, thereby, the disconnect clutch slave cylinder 311. The other end of the disconnect clutch oil supply shaft 313 is coupled to a disconnect clutch oil piston 314. The disconnect clutch oil piston 314 provides hydraulic or other type of pressure to operate the disconnect clutch slave cylinder 311. The disconnect clutch assembly 310 further includes a disconnect clutch disk 320 non-rotatably coupled to the flywheel 305. In one embodiment, the disconnect clutch disk 320 may be rotatably coupled to the flywheel 305.

The hybrid dual clutch transmission further includes a transmission clutch assembly 340. The transmission clutch assembly 340 includes the first clutch disk 341, second clutch disk 342 and the transmission clutch cover 343. The transmission clutch cover 343 is non-rotatably coupled to the rotor web 353 or rotor 352. The transmission clutch cover 343 may apply pressure to the first clutch disk 341 or second clutch disk 342 to non-rotatably couple the first clutch disk 341 or second clutch disk 342 to the web 353. The first clutch disk 341 or second clutch disk 342 may be non-rotatably coupled to the rotor web 353 individually, at the same time, or not at all.

The disconnect clutch assembly 310 further includes disconnect clutch apply springs 321 that force the disconnect clutch disk 320 into contact with a disconnect clutch reaction plate 323 fixedly coupled to the transmission clutch cover 343, thereby non-rotatably coupling the disconnect clutch reaction plate 323, transmission clutch cover 343, rotor 352, disconnect clutch disk 320, flywheel 305, and crankshaft hub 302 together. A disconnect clutch diaphragm 322 is contacted by the disconnect clutch slave cylinder 311. When hydraulic or other pressure is applied to the disconnect clutch slave cylinder 311, the disconnect slave cylinder 311 engages the disconnect clutch diaphragm 322 causing the disconnect clutch diaphragm 322 to relieve pressure between the disconnect clutch disk 320 and the disconnect clutch reaction plate 323, thereby permitting the disconnect clutch reaction plate 323 and, thus, the rotor 352 to rotate independently of the disconnect clutch disk 320, flywheel 305, and crankshaft hub 302. In one embodiment, the default position of the disconnect clutch assembly 310 is to non-rotatably couple the disconnect clutch reaction plate 323, transmission clutch cover 343, rotor 352, disconnect clutch disk 320, flywheel 305, and crankshaft hub 302 together. In one embodiment, the rotor 352, rotor web 353, and disconnect clutch reaction plate 323 are a single unit. In one embodiment, the contact point between the disconnect clutch disk 320 and the disconnect clutch reaction plate 323 is conical. The conical contact point provides for increased torque transfer capacity between the disconnect clutch disk 320 and the disconnect clutch reaction plate 323, minimizes axial forces applied to the transmission clutch assembly 340, and allows for a reduction in the size of the transmission clutch assembly 340. In one embodiment, the contact point between the disconnect clutch disk 320 and the disconnect clutch reaction plate 323 is flat.

In one embodiment, the disconnect clutch disk 320 axially contacts the disconnect clutch reaction plate 323, the first clutch disk 341 axially contacts a first side the rotor web 353, and the second clutch disk 342 axially contacts a second side of the rotor web 353. Thus, the odd gears of the hybrid dual clutch transmission, first driver gear 361, third driver gear 363, fifth driver gear 365, and reverse driver gear 367, are all engaged by contact of the first clutch disk 341 with the first side the rotor web 353 and the even gears of the hybrid dual clutch transmission, second driver gear 362 and fourth/sixth driver gear 364, are all engaged by contact of the second clutch disk 342 with the second side of the rotor web 353. In one embodiment, the points at which the disconnect clutch disk 320, first clutch disk 341, and second clutch disk 342 contact the disconnect clutch reaction plate 323 and rotor web 353 may be varied as desired.

In one embodiment, the hybrid dual clutch transmission further includes a thrust bearing 324 in contact with the rotor 352 or rotor web 353. The thrust bearing 324 prevents movement of the rotor 352 and rotor web 353 away from flywheel 305.

The first input shaft 345 includes a plurality of fixedly attached gears 361, 363, 365, 367, including a first driver gear 361, a third driver gear 363, a fifth driver gear 365, and a reverse driver gear 367. A plurality of gears 362, 364 are fixedly attached to the second input shaft 346. The gears 362, 364 fixedly attached to the second input shaft 346 include a second driver gear 362 and a fourth/sixth driver gear 364.

The hybrid dual clutch transmission also includes a first countershaft 357 and a second countershaft 358, each disposed about a different axis from each other, the first input shaft 345 and the second input shaft 346. The first countershaft 357 includes a plurality of rotatably attached gears 371, 373, 376 and at least one fixedly attached gear 391. The rotatably attached gears include a first driven gear 371, a third driven gear 373, and a sixth driven gear 376. The rotatably attached gears 371, 373, 376 are capable of rotating independently of the first countershaft 357. A first final drive pinion 391 is fixedly attached to the first countershaft 357 and rotates with the same angular velocity as the first countershaft 357. The second countershaft 358 includes a plurality of rotatably attached gears 372, 374, 375, 377 and at least one fixedly attached gear 392. The rotatably attached gears include a second driven gear 372, a fourth driven gear 374, a fifth driven gear 375, and a reverse driven gear 377. The rotatably attached gears 372, 374, 375, 377 are capable of rotating independently of the second countershaft 358. A second final drive pinion 392 is fixedly attached to the second countershaft 358 and rotates with the same angular velocity as the second countershaft 358.

Respective gears on the first input shaft 345, second input shaft 346, first countershaft 357, and second countershaft 358 are continuously meshed with one another. In particular, the first driven gear 371 is continuously meshed with the first driver gear 361, the second driven gear 372 is continuously meshed with the second driver gear 362, the third driven gear 373 is continuously meshed with the third driver gear 363, and the fifth driven gear 375 is continuously meshed with the fifth driver gear 365. In addition, one of the driver gears 364 is meshed with more than one driven gear 374, 376. In particular, the fourth/sixth driver gear 364 is continuously meshed with both the fourth driven gear 374 and the sixth driven gear 376. The reverse driven gear 377 is not meshed with any gears 361, 362, 363, 364, 365, 367 on the first input shaft 345 or second input shaft 346. Rather, the reverse driven gear 377 is continuously meshed with a reverse idler gear 368. The reverse idler gear 368 is continuously meshed with the reverse driver gear 367.

The first countershaft 357 and second countershaft 358 further include four synchronizer mechanisms (e.g., dog clutches) 381, 382, 383, 384 to selectively key a rotatably mounted gear 371, 372, 373, 374, 375, 376, 377 to its respective first countershaft 357 or second countershaft 358. A first/third gear dog clutch 381 is attached to the first countershaft 357 between the first driven gear 371 and the third driven gear 373. The first/third gear dog clutch 381 may be moved axially along the first countershaft 357 in the direction of the first driven gear 371 or moved axially along the first countershaft 357 in the opposite direction towards the third driven gear 373. A sixth gear dog clutch 384 is also attached to the first countershaft 357 along side the sixth driven gear 376. The sixth gear dog clutch 384 may be moved axially along the first countershaft 357 in the direction of the sixth driven gear 376. A second/fourth gear dog clutch 382 is attached to the second countershaft 358 between the second driven gear 372 and the fourth driven gear 384. The second/fourth gear dog clutch 382 may be moved axially along the second countershaft 358 in the direction of the second driven gear 372 or moved axially along the second countershaft 358 in the opposite direction towards the fourth driven gear 374. A fifth/reverse gear dog clutch 383 is also attached to the second countershaft 358 between the fifth driven gear 375 and the reverse driven gear 377. The fifth/reverse gear dog clutch 383 may be moved axially along the second countershaft 358 in the direction of the fifth driven gear 375 or moved axially along the second countershaft 358 in the opposite direction towards the reverse driven gear 377.

Each of the synchronizer mechanisms 381, 382, 383, 384 may be moved axially along its respective first countershaft 357 or second countershaft 358 to contact one of the rotatably attached gears 371, 372, 373, 374, 375, 376, 377. Contact between one of the synchronizer mechanisms 381, 382, 383, 384 and a corresponding rotatably attached gear 371, 372, 373, 374, 375, 376, 377 keys the rotatably attached gear 371, 372, 373, 374, 375, 376, 377 to its corresponding synchronizer mechanism 381, 382, 383, 384 and, accordingly, to its respective first countershaft 357 or second countershaft 358. Thus, contact between the synchronizer mechanism 381, 382, 383, 384 and its respective gear 371, 372, 373, 374, 375, 376, 377 locks the gear 371, 372, 373, 374, 375, 376, 377 to its respective countershaft 357, 358 such that the gear 371, 372, 373, 374, 375, 376, 377 rotates with the same angular velocity as its respective countershaft 357, 358.

The hybrid dual clutch transmission further includes a ring gear 393 continuously meshed with the first final drive pinion 391 and the second final drive pinion 392. A differential housing 394 is coupled to the transmission housing 3100. The differential housing 394 includes a differential 396 that is coupled to the ring gear 393. The differential 396 divides the torque from the ring gear 393 amongst a first halfshaft 397 and a second halfshaft 398. The first halfshaft 397 and second halfshaft 398 are connected to respective drive wheels (not shown) of the vehicle to provide propulsive force for the vehicle.

In one embodiment, pressure for the activation of the disconnect clutch diaphragm 22/322 is supplied to the disconnect clutch slave cylinder 11/311 by a mechanical linkage such as a rod. Pressure may also be supplied to the disconnect slave cylinder 11/311 by hydraulic fluid or by any other desired method. In one embodiment, the rotor 52/352 and rotor web 53/353 may be the same thing and the terms may be used synonymously.

It should be understood that the hybrid dual clutch transmission further includes a dual clutch pull rod assembly (not shown) to selectively cause the first clutch disk 41/541 or second clutch disk 42/542 to axially contact the rotor web 53/553. The disconnect clutch slave cylinder 11/511, disconnect clutch hydraulic feed 12/512, disconnect clutch oil supply shaft 13/513, and disconnect clutch oil piston 14/514 are used in combination with the dual clutch pull rod assembly. The dual clutch pull rod assembly used to control the first clutch disk 41/541 and second clutch disk 42/542 is concentric with the oil supply shaft 13/513 and would be readily understood by one of skill in the art as of the type typically used in dual clutch transmissions.

In one embodiment, the rotor 52/352 may simply be a part of the rotor web 53/353. It should be understood that the hybrid dual clutch transmission may be any type of dual clutch transmission having any number of gear ratios, layout of gears, or any other desired structural layout. In addition, the hybrid dual clutch transmission may utilize any type of clutches including, but not limited to, dry clutches or wet clutches. In one embodiment, the engine 1/301 may be an internal combustion engine such as a gasoline or diesel engine, or any other type of power source as may be desired. In one embodiment, the disconnect clutch assembly 10/310, including the flywheel 5/305, disconnect clutch slave cylinder 11/311, disconnect clutch hydraulic feed 12/312, disconnect clutch oil supply shaft 13/313, disconnect oil piston 14/314, disconnect clutch disk 20/320, disconnect clutch apply spring 21/321, and disconnect clutch diaphragm 22/322 may be implemented with any type of transmission, including a dual clutch transmission not having any electric motor 50/350 or rotor 52/352.

A hybrid dual clutch transmission having a hybrid rotor-clutch system is disclosed. Use of the rotor 52/352 and rotor web 53/353 assembly as the mating surface for the engine disconnect clutch disk 20/320, first clutch disk 41/341, and second clutch disk 42/342 provides for reduced transmission dimensions when hybridizing a dual clutch transmission. The hybrid rotor-clutch system also enables the use of a lighter flywheel 5/305 and can be used to actively reduce vibrations in the powertrain. The hybrid rotor-clutch system allows for the vehicle to be accelerated from rest utilizing only the engine 1/301, only the electric motor 50/350, or any combination of the engine 1/301 and electric motor 50/350. In an embodiment in which the default position of the disconnect clutch assembly 10/310 is to non-rotatably couple the rotor 52/352, disconnect clutch disk 20/320, flywheel 5/305, and crankshaft hub together 2/302, the hybrid rotor-clutch system allows for engine 1/301 start utilizing the electric motor 50/350 without first pressurizing hydraulics within the hybrid dual clutch transmission.

What is claimed is:

1. A hybrid dual clutch transmission, comprising:
a disconnect clutch assembly;
an electric motor having an electric motor rotor;
a first clutch assembly; and
a second clutch assembly, said disconnect clutch assembly being selectively coupled to said rotor,
wherein said first clutch assembly selectively couples said rotor to a first plurality of gears, and said second clutch assembly selectively couples said rotor to a second plurality of gears.

2. The hybrid dual clutch transmission of claim 1, wherein:
said disconnect clutch assembly comprises:
a flywheel, and
a disconnect clutch disk coupled to said flywheel;
said rotor is coupled to an electric motor rotor web;
said first clutch assembly includes a first clutch disk coupled to said first plurality of gears; and
said second clutch assembly includes a second clutch disk coupled to said second plurality of gears;
wherein said disconnect clutch disk selectively couples said flywheel to a first surface of said, said first clutch disk selectively couples a first surface of said rotor web to said first plurality of gears, and said second clutch disk selectively couples a second surface of said rotor web to said second plurality of gears.

3. The hybrid dual clutch transmission of claim 2, wherein said rotor and rotor web are an integrated unit.

4. The hybrid dual clutch transmission of claim 2, wherein said rotor and rotor web have sufficient thermal mass to permit engine only launch of a vehicle outfitted with the hybrid dual clutch transmission.

5. The hybrid dual clutch transmission of claim 2, wherein the rotor and rotor web are a vibration damper.

6. The hybrid dual clutch transmission of claim 4, wherein the default state of said disconnect clutch assembly is to couple said flywheel to said first surface of said rotor.

7. The hybrid dual clutch transmission of claim 1, wherein:
said disconnect clutch assembly comprises:
a flywheel, and
a disconnect clutch disk coupled to said flywheel;
said rotor further comprises:
an electric motor rotor web coupled to said rotor, and
a transmission clutch cover coupled to said rotor;
said first clutch assembly includes a first clutch disk coupled to said first plurality of gears; and
said second clutch assembly includes a second clutch disk coupled to said second plurality of gears;
wherein said disconnect clutch disk selectively couples said flywheel to said transmission clutch cover, said first clutch disk selectively couples a first surface of said rotor web to said first plurality of gears, and said second clutch disk selectively couples a second surface of said rotor web to said second plurality of gears.

8. The hybrid dual clutch transmission of claim 7, wherein said rotor, rotor web, and transmission clutch cover are an integrated unit.

9. The hybrid dual clutch transmission of claim 3, wherein the default state of said disconnect clutch assembly is to couple said flywheel to said transmission clutch cover.

10. The hybrid dual clutch transmission of claim 8, further comprising a thrust bearing in contact with said rotor or rotor web.

11. The hybrid dual clutch transmission of claim 1, wherein
said disconnect clutch assembly comprises:
a flywheel;
a disconnect clutch slave cylinder coupled to said flywheel;
a disconnect clutch hydraulic feed coupled to said flywheel and said disconnect clutch slave cylinder;
a disconnect clutch oil supply shaft coupled to said disconnect clutch hydraulic feed; and
a disconnect oil piston coupled to said disconnect clutch oil supply shaft,
wherein said disconnect oil piston creates pressure that passes through said disconnect clutch oil supply shaft and said disconnect clutch hydraulic feed to activate said disconnect clutch slave cylinder.

12. The hybrid dual clutch transmission of claim 11, wherein the pressure created is hydraulic pressure.

13. A transmission, comprising:
a disconnect clutch assembly comprising:
a flywheel, and
a disconnect clutch disk;
an electric motor having an electric motor rotor with an electric motor rotor web;
a first clutch assembly having a first clutch disk;
a second clutch assembly having a second clutch disk;
a first input shaft coupled to said first clutch disk; and
a second input shaft coupled to said second clutch disk,
wherein said disconnect clutch disk selectively couples said flywheel to a first surface of said rotor, said first clutch disk selectively couples a first surface of said rotor web to said first input shaft, and said second clutch disk selectively couples a second surface of said rotor web to said second input shaft.

14. The transmission of claim 13, wherein the default state of said disconnect clutch assembly is to couple said flywheel to said first surface of said rotor.

15. The transmission of claim 14, wherein said disconnect clutch assembly further comprises:
a disconnect clutch slave cylinder coupled to said flywheel;
a disconnect clutch hydraulic feed coupled to said flywheel and said disconnect clutch slave cylinder;
a disconnect clutch oil supply shaft coupled to said disconnect clutch hydraulic feed; and
a disconnect oil piston coupled to said disconnect clutch oil supply shaft,
wherein said disconnect oil piston creates pressure that passes through said disconnect clutch oil supply shaft and said disconnect clutch hydraulic feed to activate said disconnect clutch slave cylinder.

16. The transmission of claim 15, wherein the pressure created is hydraulic pressure.

17. The transmission of claim 15, wherein said rotor and rotor web have sufficient thermal mass to permit engine only launch of a vehicle outfitted with the transmission.

18. The transmission of claim 17, wherein said rotor and rotor web are a vibration damper.

19. The transmission of claim 18, wherein said rotor and rotor web are a single piece.

20. The transmission of claim 19, further comprising a thrust bearing in contact with said rotor or rotor web.
